(19) United States
(12) Patent Application Publication
(10) Pub. No.: US 2023/0182424 A1
(43) Pub. Date: Jun. 15, 2023

(54) METHOD OF MANUFACTURING AN ACOUSTIC TREATMENT PANEL AND ACOUSTIC TREATMENT PANEL OBTAINED BY SAID METHOD

(71) Applicant: Airbus Operations SAS, Toulouse (FR)

(72) Inventors: Jean-Christophe BOSSIS, TOULOUSE (FR); Laurent CALIMAN, TOULOUSE (FR); Florian RAVISE, TOULOUSE (FR); Cedric LEROUEIL, TOULOUSE (FR); Franck LEPRIZER, BLAGNAC (FR)

(21) Appl. No.: 18/076,604

(22) Filed: Dec. 7, 2022

(30) Foreign Application Priority Data
Dec. 9, 2021 (FR) 2113247

(51) Int. Cl. B29D 24/00; B29D 99/00; B29C 70/08; B29C 70/88

(52) U.S. Cl. CPC B29D 24/008; B29D 99/0021; B29C 70/088; B29C 70/887; B29L 2031/7504

(57) ABSTRACT

A method of manufacturing an acoustic treatment panel including at least one cellular structure with at least one anchor layer at the level of at least one of its faces. The anchor layer includes at least one adhesive sheet chosen from an adhesive film or a ply of pre-impregnated adhesive fibers in contact with the cellular structure. The method of manufacture includes, before the integration of the cellular structure in an acoustic treatment panel, a step of placing the anchor layer on a support, the adhesive sheet being the last to be placed, a step of placing the cellular structure on the anchor layer in contact against the adhesive sheet, and then a step of polymerization of the anchor layer and of the cellular structure.

### CROSS-REFERENCES TO RELATED APPLICATIONS

This application claims the benefit of the French patent application No. 2113247 filed on Dec. 9, 2021, the entire disclosures of which are incorporated herein by way of reference.

### FIELD OF THE INVENTION

The present application relates to a method of manufacturing an acoustic treatment panel as well as an acoustic treatment panel obtained by the method.

### BACKGROUND OF THE INVENTION

In accordance with one embodiment of the prior art that can be seen in FIGS. 1 and 2, an acoustic treatment panel 10 includes at least one cellular structure 12 positioned between an impermeable reflective layer 14 and a porous acoustically-resistive layer 16 in contact with an exterior environment in which acoustic waves propagate. The cellular structure 12 includes a plurality of cells 18 each of which forms an approximately sealed acoustic cell. In addition to this, the acoustically-resistive layer 16 includes a plurality of through-orifices configured to establish communication of the exterior environment with one of the acoustic cells.

In accordance with one application this type of panel is positioned in a nacelle of an aircraft to attenuate the noises from a jet engine.

In accordance with a configuration that can be seen in FIG. 1 the cellular structure 12 includes hexagonal cells 18 juxtaposed against one another. These cells 18 all have the same dimensions.

This kind of acoustic treatment panel 10 enables attenuation of the acoustic waves over a restricted range of frequencies, depending on the dimensions of the cells 18 and in particular of their section.

In accordance with one embodiment, before applying the reflective layer 14 and the acoustically-resistive layer 16 the method of manufacturing the acoustic treatment panel includes a step of producing the cellular structure 12, a step of shaping the cellular structure 12 to confer on it a required curvature and then an anchoring step that can be seen in FIGS. 3 and 4 aiming to apply to one face of the cellular structure 12 an anchor layer 20 consisting of an adhesive film associated with at least one ply of fibers. Among other things this anchor layer 20 enables the cellular structure 12 to keep its shape and makes it possible to prevent migration of resin towards the interior of the cells 18 when fixing the reflective layer 14.

In accordance with a first mode of operation, during this anchoring step, the cellular structure 12 is positioned on a support 22, its face 12.1 on which the anchor layer 20 must be mounted being oriented upwards. After this the adhesive film and then the plies of fibers are mounted on the face 12.1 of the cellular structure 12. This assembly is then coated with a polymerization coating (not represented) and then subjected to a temperature of the order of 180° C. and to a pressure of the order of 1 bar to fasten the anchor layer 20 and the cellular structure 12 together. As illustrated in FIG. 3, following the polymerization step the anchor layer 20 is not plane but features depressed zones 24 in line with each cell 18 with a depth P, as illustrated in FIG. 2. This phenomenon is known as “telegraphing”. The greater the section of the cells 18 the more accentuated this phenomenon.

In accordance with a second mode of operation that can be seen in FIG. 4, to limit this phenomenon of telegraphing a conformation plate 26 is inserted between the plies of fibers and the polymerization coating during polymerization. This solution makes it possible to reduce the depression of the anchor layer 20 in line with the cells 18. Thus, if the cellular structure 12 includes cells 18 having a dimension less than or equal to 10 mm between two opposite summits, the telegraphing phenomenon is acceptable.

This cell dimension is suitable for the attenuation of certain soundwaves. For other soundwaves the cells 18 must have larger sections. Now in this case the phenomenon of telegraphing is excessive.

The present invention aims to remedy some or all of the disadvantages of the prior art.

### SUMMARY OF THE INVENTION

To this end, the invention has for object a method of manufacturing an acoustic treatment panel including a reflective layer, at least one acoustically-resistive layer and at least one cellular structure inserted between the reflective layer and the acoustically-resistive layer, the cellular structure including cells and first and second faces at the level of which the cells open and including at least one anchor layer at the level of at least one of the first and second faces, the anchor layer including at least one adhesive sheet, chosen from an adhesive film or a ply of pre-impregnated adhesive fibers in contact with the cellular structure, the method of manufacture including for each cellular structure a step of polymerization of the anchor layer and of the cellular structure and then a step of assembly of the acoustically-resistive layer(s), the cellular structure(s) and the reflective layer.

According to the invention, the method includes, before the step of polymerization of each cellular structure and of its anchor layer, a step of placing the anchor layer on a support, the adhesive sheet being the last to be placed, as well as a step of placing the cellular structure on the anchor layer in contact against the adhesive sheet.

This method makes it possible to obtain a cellular structure with a quasi-plane anchor layer or one with small depressions.

In accordance with one embodiment, the anchor layer includes at least one adhesive film and at least one ply of fibers, the method including a step of placing the ply or plies of fibers on the support before the step of placing the adhesive film.

In accordance with another embodiment, the anchor layer includes only one ply of pre-impregnated adhesive fibers.

In accordance with another embodiment, the anchor layer includes only one adhesive film.

In accordance with another feature the method includes a step of conformation of the cellular structure according to a required curvature, the support on which the anchor layer is placed having a surface configured as a function of the curvature required for the cellular structure.

In accordance with another feature, before an assembly step, the method includes a step of fixing at least one additional layer against the anchor layer.

In accordance with a first embodiment, the method includes a step of placing the acoustically-resistive layer on a support, a step of placing on the acoustically-resistive layer two cellular structures stacked one on the other, the anchor layer for each cellular structure being positioned above the cellular structure to which it is connected, a step of placing the reflective layer against the anchor layer of the last cellular structure to be placed as well as a step of polymerization or of consolidation aiming to make a connection between the acoustically-resistive layer, the two cellular structures and the reflective layer.

In accordance with a second embodiment, the method includes a step of placing the acoustically-resistive layer on a support, a step of placing the cellular structure on the acoustically-resistive layer, the anchor layer being positioned above the cellular structure, a step of placing the reflective layer against the anchor layer of the cellular structure as well as a step of polymerization or of consolidation aiming to make a connection between the acoustically-resistive layer, the cellular structure and the reflective layer.

The invention also has for object an acoustic treatment panel obtained by the method with any of the above features.

### BRIEF DESCRIPTION OF THE DRAWINGS

Other features and advantages will emerge from the following description of the invention given by way of example only with reference to the appended drawings, in which:

FIG. 1 is a view from above of an acoustic treatment panel illustrating a prior art embodiment,

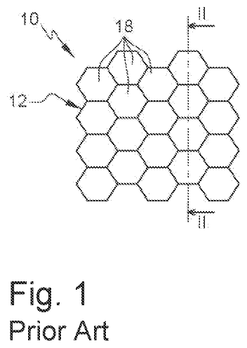

FIG. 2 is a section of the acoustic treatment panel on the line II-II in FIG. 1,

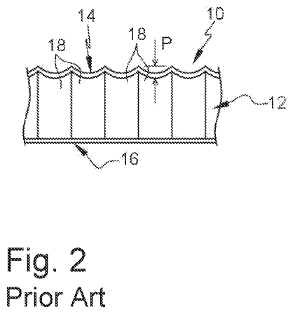

FIG. 3 is a section of a cellular structure and an anchor layer illustrating a first prior art mode of operation,

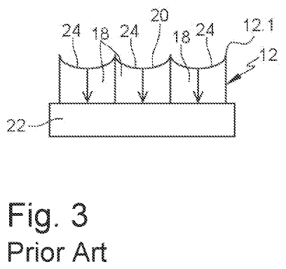

FIG. 4 is a section of a cellular structure and of an anchor layer illustrating a second prior art mode of operation,

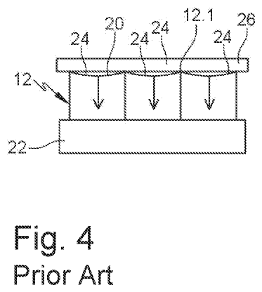

FIGS. 5A-5C are diagrammatic representations of an anchor layer and of a cellular structure during the various steps of a first mode of operation illustrating the invention,

FIG. 6 is a section of a cellular structure and of an anchor layer illustrating one embodiment of the invention,

FIGS. 7A-7C are diagrammatic representations of an adhesive film and of a cellular structure during various steps of the second mode of operation of the invention,

FIG. 8 is a diagrammatic representation of a cellular structure with an anchor layer illustrating one embodiment of the invention,

FIG. 9 is a diagrammatic representation of an acoustic treatment panel including two stacked cellular structures as illustrated in FIG. 8 illustrating one embodiment of the invention,

FIG. 10 is a diagrammatic representation of an acoustic treatment panel including a cellular structure as illustrated in FIG. 8 illustrating one embodiment of the invention, and

FIG. 11 is a diagrammatic representation of the various steps of a method of manufacturing an acoustic treatment panel illustrating one embodiment of the invention.

### DETAILED DESCRIPTION OF THE PREFERRED EMBODIMENTS

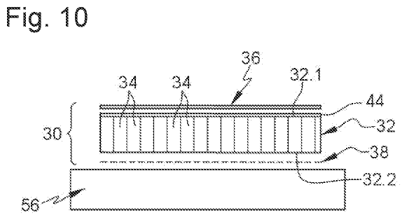

In an embodiment that can be seen in FIG. 10 an acoustic treatment panel 30 includes at least one cellular structure 32 including cells 34 and first and second faces 32.1, 32.2 onto which the cells 34 open, a reflective layer 36 as well as at least one acoustically-resistive layer 38, the cellular structure 32 being inserted between the reflective layer 36 and the acoustically-resistive layer 38. In operation the acoustically-resistive layer 38 has a face opposite the cellular structure 32 in contact with an exterior environment in which acoustic waves propagate.

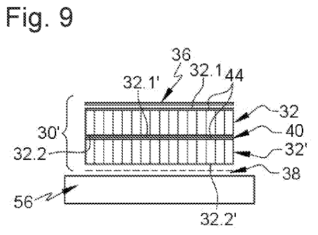

In accordance with a first embodiment that can be seen in FIG. 10 the acoustic treatment panel 30 includes only one cellular structure 32. In a second embodiment that can be seen in FIG. 9 the acoustic treatment panel 30′ includes two stacked cellular structures 32, 32′, a reflective layer 36 being pressed against a first face 32.1 of a first cellular structure 32, an acoustically-resistive layer 38 being pressed against a second face 32.2′ of the second cellular structure 32′, an intermediate acoustically-resistive layer 40, also termed a septum, being inserted between the second face 32.2 of the first cellular structure 32 and the first face 32.1′ of the second cellular structure 32′.

The cellular structure may be made of metal or of a composite material. The dimensions of the cells 34 may vary from one panel to another. These cells may have a dimension between two opposite summits greater than 10 mm, for example of the order of 19 mm.

The acoustically-resistive layer 38 comprises one or more layers. It may be made of metal and/or of a composite material. In the same way, the intermediate acoustically-resistive layer 40 includes one or more layers. It may be made of metal and/or of a composite material. In the latter case it includes at least one reinforcing ply and is pierced or perforated.

The reflective layer 36 includes one or more layers. It may be made of metal or of a composite material.

The cellular structure 32, the reflective layer 36, the acoustically-resistive layer 38 and the intermediate acoustically-resistive layer 40 are not described in more detail because they are known to the person skilled in the art and may be identical to those of the prior art.

The cellular structure 32, 32′ includes at least one anchor layer 44 positioned at the level of at least one of the first and second faces 32.1, 32.2 of the cellular structure 32, 32′. In a first configuration that can be seen in FIGS. 9 and 10 the anchor layer 44 is inserted between the cellular structure 32 and the reflective layer 36. In a second configuration that can be seen in FIG. 9 the anchor layer 44 is inserted between two cellular structures 32, 32′.

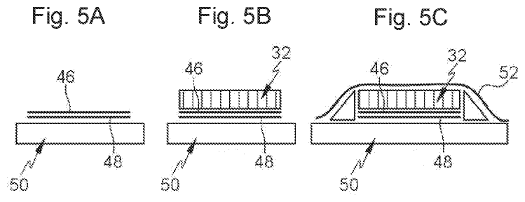

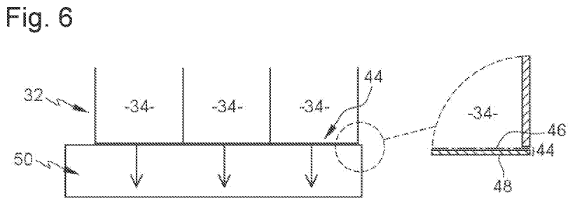

In accordance with a first embodiment that can be seen in FIGS. 5A-5C and 6, the anchor layer 44 includes at least one adhesive film 46 in contact with the cellular structure 32, 32′, as well as at least one ply of fibers 48. In one configuration the anchor layer 44 includes a single adhesive film 46. It may include one or more plies of fibers 48.

The plies of fibers may comprise fibers of carbon, glass or any other material. The ply of fibers may be woven or non-woven. As a general rule, the ply of fibers 48 is pre-impregnated with a resin. For the remainder of the description there is meant by a ply of fibers 48, one or more plies of fibers 48.

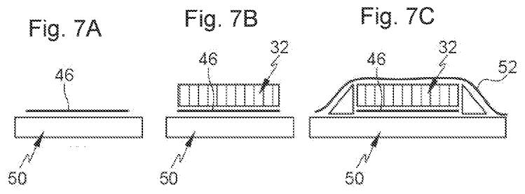

In accordance with a second embodiment that can be seen in FIG. 7B, the anchor layer 44 includes at least one adhesive film 46 in contact with the cellular structure 32, 32′ and does not include any plies of fibers.

In accordance with another embodiment, the anchor layer 44 includes only one ply of adhesive pre-impregnated fibers (known as self-adhesive prepreg fibers) sufficiently loaded with resin for there to be no need for an adhesive film for adhesion to the cellular structure 32, 32′. The plies of fibers may comprise carbon fibers, glass fibers or fibers of any other material. The ply of fibers may be woven or non-woven.

In a first mode of operation that can be seen in FIG. 5A, the ply of fibers 48 is positioned on a support 50 and the adhesive film 46 is then positioned on the ply of fibers 48. After this the cellular structure 32 is positioned on the adhesive film 46 as illustrated in FIG. 5B. A polymerization coating 52 is then positioned on the cellular structure 32 and connected in sealed manner to the support 50 as shown in FIG. 5C. This assembly covered by the polymerization coating is subjected to a temperature of the order of 180° C. and a pressure of the order of 1 bar to fasten together the anchor layer 44 and the cellular structure 32.

In a second mode of operation that can be seen in FIGS. 7A-7C, the adhesive film 46 is positioned on a support 50 as illustrated in FIG. 7A. After this the cellular structure 32 is positioned on the adhesive film 46 as illustrated in FIG. 7B. A polymerization coating 52 is then positioned on the cellular structure 32 and connected in sealed manner to the support 50 as shown in FIG. 7C. This assembly, covered by the polymerization coating, is subjected to a temperature of the order of 180° C. and a pressure of the order of 1 bar to fasten together the anchor layer 44 and the cellular structure 32.

Regardless of the mode of operation, the method of manufacturing an acoustic treatment panel 30, 30′ includes a step of placing on a support 50 an anchor layer 44 including at least one adhesive sheet chosen from an adhesive film 46 or a ply of pre-impregnated adhesive fibers, the adhesive sheet being the last to be placed, a step of placing the cellular structure 32 on the anchor layer 44 in contact against the adhesive sheet, a step of applying a polymerization coating 52 and then a polymerization step aiming to fasten together the anchor layer 44 and the cellular structure 32 in order to obtain a cellular structure 32 including an anchor layer 44.

By sheet is meant a thin layer of flexible material.

The support 50 may be plane or curved as a function of the curvature required for the acoustic treatment panel 30, 30′.

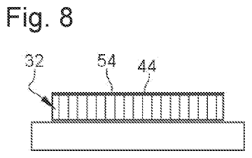

In a mode of operation that can be seen in FIG. 8, before a step of assembling the cellular structure 32, 32′, the reflective layer 36 and the acoustically-resistive layer 38, the method of manufacturing an acoustic treatment panel includes a step of fixing at least one additional layer 54 against the anchor layer 44, such as a reinforcing ply, to obtain an intermediate acoustically-resistive layer 40.

The method of manufacture of the invention may be used to produce acoustic treatment panels 30 having wide cells 34 and/or comprising two cellular structures 32, 32′. Moreover, it makes it possible to obtain an intermediate acoustically-resistive layer 40 with a single reinforcing ply with no telegraphing phenomenon, which makes it possible to obtain an optimum connection between the two cellular structures 32, 32′.

In a first mode of operation that can be seen in FIG. 9 the method of manufacturing an acoustic treatment panel includes for each cellular structure 32, 32′ a step of applying an acoustically-resistive layer 38 on a support 56, and a step of placing on the acoustically-resistive layer 38 two cellular structures 32, 32′ stacked one on the other, for each cellular structure 32, 32′ the anchor layer 44 being positioned above the cellular structure 32, 32′ to which it is connected, followed by a step of placing a reflective layer 36 against the anchor layer 44 of the last cellular structure 32.

Finally, the method includes a polymerization or consolidation step aiming to make the connection between the acoustically-resistive layer 38, the two cellular structures 32, 32′ and the reflective layer 36.

In a second mode of operation that can be seen in FIG. 10, the method of manufacture includes a step of placing an acoustically-resistive layer 38 on a support 56, a step of placing a cellular structure 32 on the acoustically-resistive layer 38, the anchor layer 44 being positioned on top of the cellular structure 32, followed by a step of placing a reflective layer 36 against the anchor layer 44 of the cellular structure 32.

Finally, the method includes a polymerization or consolidation step aiming to make the connection between the acoustically-resistive layer 38, the cellular structure 32 and the reflective layer 36.

Regardless of the mode of operation, the method of manufacturing an acoustic treatment panel 30, 30′ includes a step of assembling at least one acoustically-resistive layer 38, at least one cellular structure 32, 32′ with an anchor layer 44, and a reflective layer 36.

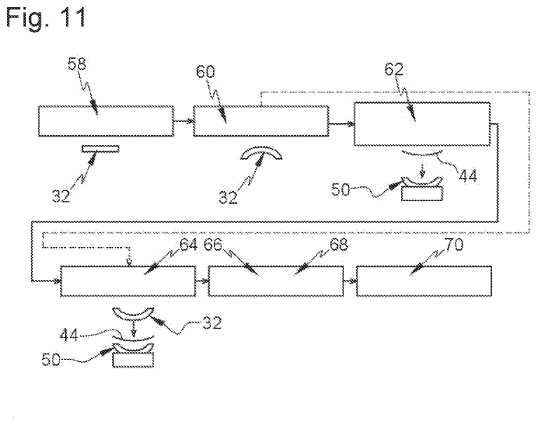

In an embodiment that can be seen in FIG. 11, the method of manufacturing an acoustic treatment panel includes a step 58 of manufacturing a cellular structure 32, a step 60 of conformation of the cellular structure 32 in accordance with a required curvature, a step 62 of placing an anchor layer 44 against a surface of a support 50 having a surface against which is placed the anchor layer 44 configured as a function of the curvature required for the cellular structure 32, a step 64 of placing the conformed cellular structure 32 against the anchor layer 44, a step 66 of placing a polymerization coating, and a polymerization step 68 aiming to fasten together the anchor layer 44 and the cellular structure 32.

After this, the method of manufacturing an acoustic treatment panel includes a step 70 of assembling a reflective layer 36, an acoustically-resistive layer 38 and at least one cellular structure 32, 32′ with its anchor layer 44, inserted between the reflective layer 36 and the acoustically-resistive layer 38.

The anchor layer 44 may be placed manually or automatically using a placement machine.

At the time of polymerization, the assembly formed by the anchor layer 44 and the cellular structure 32 covered by the polymerization coating is subjected to a temperature of the order of 180° C. and a pressure of the order of 1 bar to fasten together the anchor layer 44 and the cellular structure 32.

The method in accordance with the invention enables a cellular structure 32, 32′ to be obtained with an anchor layer 44 that is quasi-plane or has small depressions. It is therefore possible to connect with perfect contact two cellular structures 32, 32′ or a cellular structure 32 and a reflective layer 36.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of manufacturing an acoustic treatment panel comprising:
a reflective layer,
at least one acoustically-resistive layer, and
at least one cellular structure inserted between the reflective layer and the acoustically-resistive layer,
said cellular structure including cells and first and second faces at a level of which the cells open and including at least one anchor layer at a level of at least one of the first and second faces, said anchor layer including at least one adhesive sheet, chosen from an adhesive film or a ply of pre-impregnated adhesive fibers in contact with the cellular structure,
the method of manufacture comprising, for each cellular structure, the steps of:
placing the anchor layer on a support, the adhesive sheet being the last to be placed,
placing the cellular structure on the anchor layer in contact against the adhesive sheet,
polymerizing the anchor layer and the cellular structure, and
assembling the acoustically-resistive layer(s), the cellular structure(s) and the reflective layer.

2. The method according to claim 1,
wherein the anchor layer includes at least one adhesive film and at least one ply of fibers, and
wherein the method includes a step of placing the ply or plies of fibers on the support before the step of placing the adhesive film.

3. The method according to claim 1, wherein the anchor layer includes only one ply of pre-impregnated adhesive fibers.

4. The method according to claim 1, wherein the anchor layer includes only one adhesive film.

5. The method according to claim 1,
wherein the method includes a step of conformation of the cellular structure according to a required curvature, and
wherein the support on which the anchor layer is placed has a surface configured as a function of the curvature required for the cellular structure.

6. The method according to claim 1, wherein, before an assembly step, the method includes a step of fixing at least one additional layer against the anchor layer.

7. The method according to claim 1, wherein the method includes the steps:
placing the acoustically-resistive layer on a support,
placing on the acoustically-resistive layer two cellular structures stacked one on the other, the anchor layer for each cellular structure being positioned above the cellular structure to which the anchor layer is connected,
placing the reflective layer against the anchor layer of a last cellular structure to be placed,
polymerizing or consolidating, aiming to make a connection between the acoustically-resistive layer, the two cellular structures and the reflective layer.

8. The method according to claim 1, wherein the method includes the steps:
placing the acoustically-resistive layer on a support,
placing the cellular structure on the acoustically-resistive layer,
positioning the anchor layer above the cellular structure,
placing the reflective layer against the anchor layer of the cellular structure,
polymerizing or consolidating, aiming to make a connection between the acoustically-resistive layer, the cellular structure and the reflective layer.

9. An acoustic treatment panel obtained by the method according to claim 1.
